(19) United States
(12) Patent Application Publication
(10) Pub. No.: US 2008/0230320 A1
(43) Pub. Date: Sep. 25, 2008

(54) Vehicle for High Lift Work

(75) Inventors: Masanobu Soeda, Saitama (JP); Masakazu Yakuwa, Saitama (JP)

Correspondence Address: Studebaker & Brackett PC, 1890 Preston White Drive, Suite 105, Reston, VA, 20191, US

(73) Assignee: KABUSHIKI KAISHA AICHI CORPORATION, Ageo-shi (JP)

(21) Appl. No.: 10/591,462

(22) PCT Filed: Jul. 4, 2006
(86) PCT No.: PCT/JP2006/313642

§ 371 Date: Feb. 12, 2007

(30) Foreign Application Priority Data
Jul. 5, 2005 (JP) 2005-195801

(51) Int. Cl. B66F 9/06

(52) U.S. Cl. 187/222

(57) ABSTRACT

The vehicle for high lift work 10 comprises: a lifting and lowering device 4, 5 disposed on the vehicle; a work platform 9 which is attached to the lifting and lowering device 4, 5 and raised and lowered by the lifting and lowering device 4, 5; an operating device 20, provided on the work platform 9, for operating the lifting and lowering device 5; and a hoisting device 30, provided on the work platform 9, for lifting a heavy load 60 up and down toward the work platform 9, wherein the operating device 20 and the hoisting device 30 are disposed in the vicinity of one of margins (91a) forming a floor face 91 of the work platform 9.

### TECHNICAL FIELD

The present invention relates to a vehicle for high lift work provided with a hoisting device at a work platform of the vehicle.

### BACKGROUND ART

As such a vehicle for high lift work, there is generally known a vehicle for high lift work in which a boom configuring a lifting and lowering device is turned, derricked, and stretched to move a work platform, which is attached to a leading end of the boom, up to a desired height so that a worker can perform a high-place work on the work platform. As the work platform, there is known the one which is provided with a handrail (safety fence) around a laterally wide floor face thereof so as to secure a wide work space (see Japanese Patent Application Laid-Open No. 2001-206692, for example). Further, the work platform is provided with an operating device for operating the lifting and lowering device.

Moreover, there is known a vehicle for high lift work which is provided with a hoisting device so that a high-place work where a heavy load is used can be carried out effectively (see Japanese Patent Application Laid-Open No. H7-144892, for example). As such a hoisting device, there is generally known a hoisting device in which a hook is attached to a wire hanging from a pulley attached to a leading end of a sub-boom which can be freely turned, hoisted, and stretched, so that a heavy load, which is suspended from the hook, can be lifted up to a height or dropped to the ground by a winch taking up or down the wire.

It should be noted that it is necessary to lift up at least a lower end of the heavy load to a position higher than an upper edge of the handrail in order to carry the heavy load onto the work platform by using the hoisting device. In view of such a hoisting device, as described in Japanese Patent Application Laid-Open No. H7-144892, the conventional hoisting device is configured such that a hoisting supporting point of the sub-boom is arranged on a position higher than the upper edge of the handrail so that a heavy load can be easily carried onto a work platform.

### Problems to be Solved by the Invention

Conventionally, as described in Japanese Patent Application Laid-Open No. H7-144892, the hoisting device is generally disposed in the center of the laterally wide floor face of the work platform, since this configuration is advantageous in securing the strength of a structural object. However, in such a configuration, a work has to be performed on the work platform in a periphery of the hoisting device provided in the center. Therefore, the problem is that a wide space for handling the carried heavy load cannot be secured and the working efficiency decreases due to a troublesome movement on the work platform.

As described above, since the heavy load, which is lifted up from the ground, can be carried to the work platform after a lower end section of the heavy load passes the upper part of the handrail, the hook needs to be positioned higher by raising the sub-boom. However, in the case of an embodiment in which the hoisting device is disposed in the center of the floor face, the hook cannot be positioned in a level high enough to lift the heavy load unless increasing the derricking angle because the distance between the center and a margin of the work platform is vaguely short. If the derricking angle is increased, in the case of a large-sized heavy load (particularly a wide heavy load) the boom becomes an obstacle to the heavy load, whereby the heavy load cannot be carried to the work platform easily.

Further, if the hoisting supporting point of the sub-boom is arranged at a position higher than the handrail, the hoisting device is positioned so as to protrude upward even in a stored state. Therefore, in the case of moving the work platform by operating the lifting and lowering device when the hoisting device is in the stored state, the section protruding upward above the handrail in the hoisting device may obstruct a surrounding structural object, deteriorating the workability.

Moreover, when the heavy hoisting device is disposed at a high position, the center of gravity of the entire vehicle is raised, deteriorating the stability and operability when the vehicle travels on a curve. According to the circumstances, other problem is that a mechanism for enhancing roll rigidity of the vehicle body is required separately in order to prevent an inclination of the vehicle body when traveling on a curve to secure the stability.

### DISCLOSURE OF THE INVENTION

In view of such problems, an object of the present invention is to provide a vehicle for high lift work, which is provided with a hoisting device at a work platform thereof, and capable of securing a wide work space on the work platform and easily carrying a heavy load to the work platform by means of the hoisting device.

Another object of the present invention is to provide a vehicle for high lift work capable of preventing deterioration of vehicle traveling performance and workability.

### Means to Solve the Problems

In order to achieve the above objects, the vehicle for high lift work of the present invention is a vehicle for high lift work, comprising: a vehicle capable of traveling; a lifting and lowering device disposed on the vehicle (a boom 5 in embodiments, for example); a work platform which is attached to the lifting and lowering device and raised and lowered by the lifting and lowering device; an operating device provided on the work platform and for operating the lifting and lowering device; and a hoisting device provided on the work platform and for lifting a heavy load up and down, wherein the operating device and the hoisting device are disposed in the vicinity of one of margins forming a floor face of the work platform.

Further, it is preferred that the hoisting device be configured so that a turning motion thereof is allowed only in a predetermined angular range and that the operating device and an operation space for operating the operating device be positioned outside the angular range. Furthermore, preferably the hoisting device comprises a boom which can be freely turned, derricked, and stretched (a sub-boom 33 in the embodiments, for example) and a hook which is attached to a wire hanging downward from a leading end of the boom, and the hoisting device is preferably configured so that the hook can be always positioned outside the work platform and turned when the boom is turned at a predetermined derricking angle and by a predetermined stretched amount. Moreover, it is preferred that a handrail be arranged in a standing position so as to surround the floor face of the work platform, and that an upper end of the hoisting device in a housing state be positioned below an upper edge of the handrail.

### Advantageous Effects of the Invention

According to the above configurations of the vehicle for high lift work of the present invention, since both the operating device and the hoisting device are disposed in the vicinity of a margin of the work platform, a free space is formed in the vicinity of a margin opposite to the margin to which the both devices are brought close. Therefore, compared to a conventional configuration in which a free space is formed around the hoisting device provided in the center, in this vehicle for high lift work of the present invention a large work space can be secured in which a worker can move and perform a work and the working efficiency can be improved.

In this vehicle for high lift work, a turning motion of the hoisting device may be tolerated only in a predetermined angular range, and the operating device and the operating space may be positioned outside the angular range. In this manner, the hoisting device and a heavy load which is lifted up by the hoisting device can be prevented from moving over the operating device and the operating space. Accordingly, a worker operating the lifting and lowering device can be separated from a worker operating the hoisting device, and, even if the worker operating the hoisting device performs an erroneous operation, the worker operating the lifting and raising device can be prevented from being caught between the lifting and lowering device and the hoisting device, thus a safe vehicle for high lift work can be provided.

The hoisting device may be configured with a boom which can be freely turned, derricked, and stretched and a hook which is attached to a wire hanging downward from a leading end of the boom, and the leading end of the boom and the hook may be positioned outside the work platform even when raising the boom at a large derricking angle from the margin to which the operating device and the hoisting device are brought close. In this manner, even when a long heavy load is hung in a vertical direction, the heavy load can be easily lifted onto the work platform from the margin. In the case where the heavy load may obstruct the sub-boom after increasing the derricking angle, even if the derricking angle is reduced compared to the configuration in which the conventional hoisting device is positioned in the center of the floor face, the leading end of the boom and the hook can be positioned away from the far margin and outside the work platform. Therefore, the boom and the heavy load can be prevented from obstructing each other and the heavy load can be caused to pass the handrail and easily brought into the work platform.

When the sub-boom with the predetermined stretched amount and at the predetermined derricking angle is turned, the hook may always pass through the outside of the work platform. Accordingly, even when the sub-boom is turned in a state in which the heavy load is hung by the hook, the heavy load does not hit the work platform or pass above the work platform. Therefore, the heavy load can be prevented from hitting the worker boarding the work platform, and a safe vehicle for high lift work can be provided.

It is preferred that the height of the hoisting device in the stored state be lower than the height of the handrail which is provided in a standing position on the work platform. In this manner, it is possible to obtain the vehicle height which is same as that of a vehicle for high lift work which is not provided with a hoisting device, and the vehicle can travel or the work platform can be moved in the same manner as with such a vehicle for high lift work. Furthermore, the vehicle height of the vehicle for high lift work of the present invention can be lowered, compared to the conventional vehicle for high lift work in which the hoisting device is provided so as to be higher than the handrail. Therefore, the center of gravity is made lower than that of the conventional vehicle for high lift work and the vehicle can be caused to travel stably.

### BRIEF DESCRIPTION OF THE DRAWINGS

FIG. 1 is a side view of the vehicle for high lift work according to the present invention;

FIG. 2 is a plan view of the work platform of the vehicle for high lift work;

FIG. 3 is a plan view of the work platform showing a range of operation of the hoisting device; and

FIG. 4 is a side vice of the hoisting device viewed in the direction of the arrow IV-IV in FIG. 2, wherein FIG. 4A shows a state in which a lifting work is performed starting from a margin in the vicinity of the hoisting device, and FIG. 4B shows a state in which the lifting work is performed starting from a margin far from the hoisting device.

### BEST MODE FOR CARRYING OUT THE INVENTION

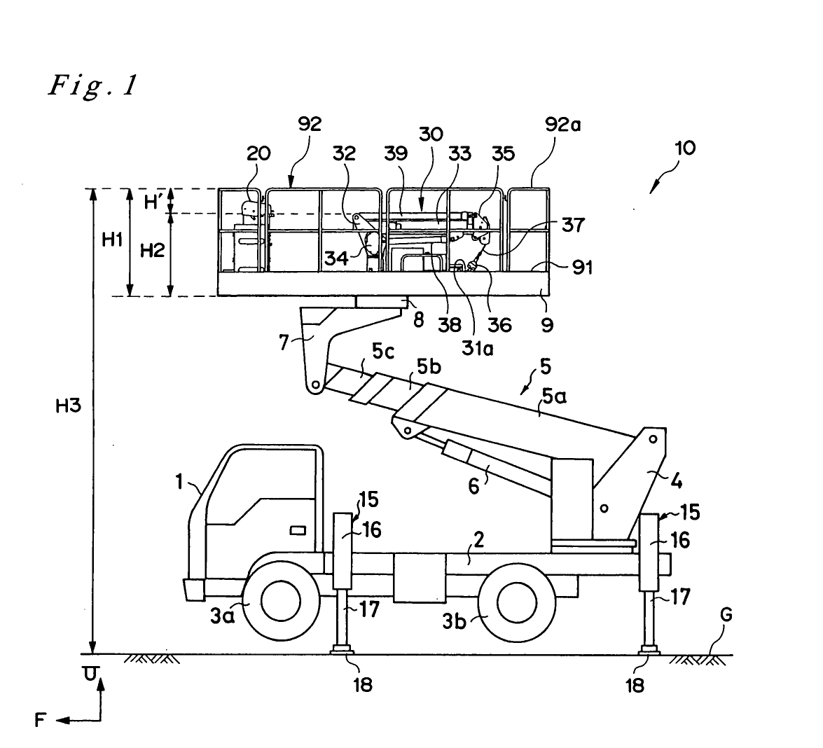

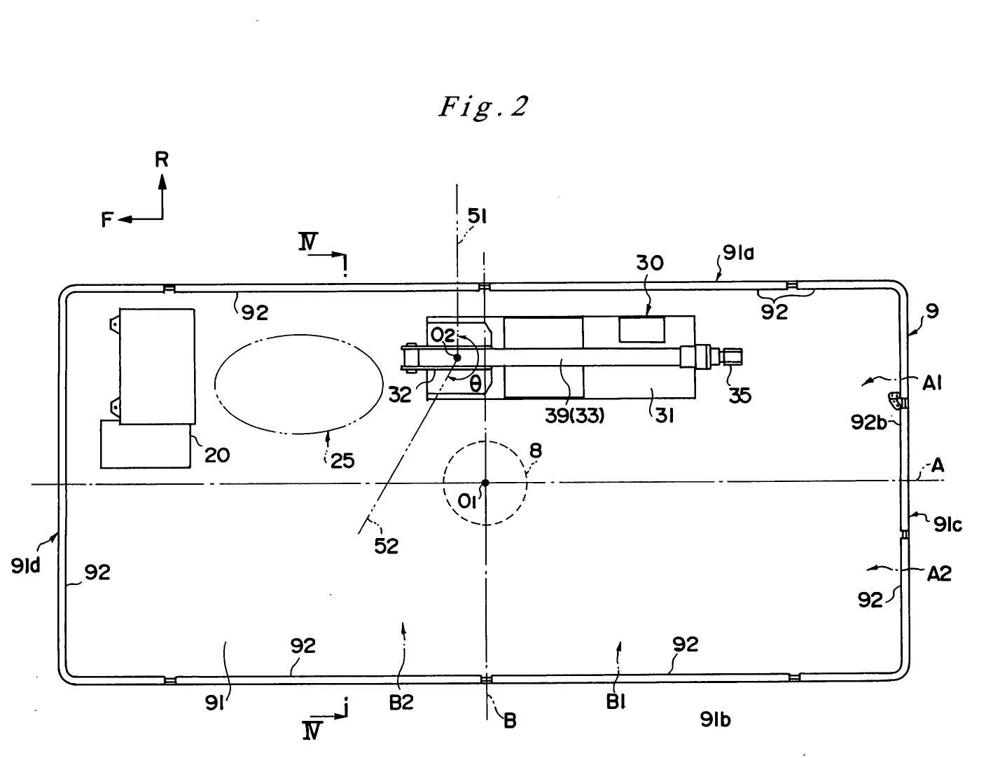

Preferred embodiments of the present invention are described hereinafter with reference to the drawings. FIG. 1 shows the vehicle for high lift work according to the present invention. This vehicle for high lift work 10 is configured based on a track vehicle which has a cabin 1 and front and rear wheels 3a, 3b so as to be able to travel freely. Hereinafter, the embodiments are explained in which the direction of the arrow F shown in FIGS. 1 and 2 is the front, the direction of the arrow U shown in FIG. 1 is the top, and the direction of the arrow R shown in FIG. 2 is the right side of the vehicle for high lift work.

A turning base 4, which is driven by a turn motor (not shown) so as to be freely turn in a horizontal direction, is disposed on a body 2 of the vehicle. A boom 5, which is freely hoisted by a hoisting cylinder 6, is pivotally connected to the turning base 4. The boom 5 is configured by combining an intermediate boom 5b and a leading end boom 5c in the form of a nest in a base end boom 5a which is pivotally connected to the turning base 4, and caused to freely stretch or contract by an embedded extension cylinder (not shown). A leading end section of the leading end boom 5c is attached with a supporting member 7 swingably in a vertical direction. A work platform 9 is attached onto the supporting member 7 via an oscillating device 8 so as to be able to freely turn (oscillate) in a horizontal direction. It should be noted that a leveling device (not shown) is disposed between the leading end boom 5c and the supporting member 7. The work platform 9 is always held horizontally by this leveling device regardless of a hoisting motion of the boom 5.

The work platform 9 is provided with a hoisting device 30. The hoisting device 30 can be hoisted freely by a base 31 attached detachably onto a work floor 91 of the work platform 9, a turning post 32 provided on the base 31 and driven freely so as to be able to turn horizontally, and a hoisting cylinder 38 connected pivotally to the turning post 32, and comprises the sub-boom 33 extended freely by a extension cylinder 39 provided directly above the sub-boom 33, a winch 34 attached to the turning post 32 and taking up or down a wire 37, a pulley 35 supported by a bracket which is attached to a leading end section of the sub-boom 33, and a hook 36 attached to the wire 37 hanging downward from the pulley 35. The sub-boom 33 is configured by combining an intermediate boom 33b and a leading end boom 33c in the form of a nest in a base end boom 33a which is pivotally connected to the turning base 32. It should be noted that in such hoisting device 30 the leading end of the sub-boom 33, the pulley 35, and the hook 36 are positioned on substantially the same area when viewed planarly.

The worker boards such work platform 9 and performs a high-place work including a lifting work. The work platform 9 is provided with an upper operating device 20 so that the worker can perform an operation to move the work platform 9 when performing the high-place work. The upper operating device 20 has a chassis structure has disposed therein a lever and a switch (not shown) for operating the upper operating device 20. The worker can operate the lever and switch disposed in the upper operating device 20 to perform a high-place work by turning the turning base 4, hoisting and extending the boom 5, and oscillating the work platform 9 to elevate the work platform 9 to a desired height.

When performing a high-place work, since it is difficult to stably support the body 2 by using only the front and rear wheels 3a, 3b, four positions such as the front, rear, right and left positions on the body 2 is each provided with an outrigger jack 15. Each outrigger jack 15 comprises an outer box 16 fixed to an outrigger beam (not shown) which can be extended freely in a vehicle width direction, an inner box 17 which is stored inside the outer box 16 and freely extended downward by a built-in jack cylinder (not shown), and a jacking pad 18 attached to a lower end of the inner box 17. When performing a high-place work, the body 2 can be raised and supported by extending the inner box 17 downward and grounding the jacking pad 18 by means of the jack cylinder.

Further, a remote controller (not shown) is cable-connected to the hoisting device 30. The worker on the work platform 9 can operate this remote controller to lift a heavy load 60 by turning the turn post 32, hoisting and extending the sub-boom 33, and taking up and down the winch 34. The operator can operate the hoisting device 30 at a position suitable for performing the work, while moving within a range corresponding to the length of the cable of the remote controller on the work platform 9.

As shown in FIG. 1 and FIG. 2, the work platform 9 is provided with a handrail 92 in a standing position which surrounds margins 91a through 91d of the rectangular work floor 91. It should be noted that the present embodiment explains the direction of the work platform 9 in relation to the arrows shown in FIG. 2, the direction of the work platform on the vehicle for high lift work of the present invention is not limited to the following direction within the scope of the present invention.

The work floor 91 is in the form of a rectangle (approximately 4.5 m×approximately 2 m) in which the right margin 91a and the left margin 91b are long and the rear margin 91c and the front margin 91d are short. The center of rotation of the oscillating device 8 is positioned on a center O1 of the work floor 91. The handrail 92 is configured such that a plurality of fence members made from a metallic pipe material are attached thereto so as to surround the margins 91a through 91d of the work floor 91 without forming any spaces therebetween, whereby the worker is prevented from falling from the work platform 9. Upper edge sections 92a of the handrail 92 are arranged to be on the same level with one another so that the worker can easily put his hand (approximately 1 m). Furthermore, the fence member, which is attached to the rear margin 91c, can be opened and closed easily and functions as a door. The worker opens this door 92b to board the work platform 9.

Here, the rectangle work floor 91 is divided into a right region A1 and a left region A2 by an axis A running through the center O1 in a longitudinal direction so as to be in parallel with the right margin 91a of the work floor 91. The upper operating device 20 is positioned on a front corner section provided on the right region A1. The hoisting device 30 is positioned in a central section provided in the right region A1 and is disposed so as to be adjacent to the upper operating device 20 in the front-and-back direction. By being disposed in which manner, the devices 20 and 30 are disposed in the vicinity of the right margin 91a. The worker operates the lever and the switch provided in the upper operating device 20 in an operating space 25 provided between the upper operating device 20 and the hoisting device 30. By disposing the upper operating device 20 and the hoisting device 30 in the right region A1, a free space is formed in the left region A2.

FIG. 1 and FIG. 2 show that the sub-boom 33 is in a storage location and the hoisting device 30 is in a state of being stored. The sub-boom 33 in the storage location is stretched by the minimum amount so that the derricking angle thereof extends horizontally, and a leading end thereof is directed in a direction (backward) opposite of the upper operating device 20 so as to be at the angle of rotation. In the hoisting device 30, the sub-boom 33 is in the storage location as described above and the hook 36 is locked to a hook storing tool 31a attached onto the base 31, so as to be in the stored position. The hoisting device 30 is in the stored position when, for example, the work platform 9 is moved up to a high place before a work is performed, and when the work platform 9 is lifted down from the high place after the work is performed, or when the vehicle for high lift work is moved.

When the hoisting device 30 is in the stored position, a height H2 of the hoisting device 30, which is expressed in the distance between the work floor 91 and an upper end of the turning post 32, is lower than a height H1 of the handrail 92, which is expressed in the distance between the work floor 91 and the upper edge section 92a. Therefore, the upper end of the hoisting device 30 positioned downward by a predetermined distance H′ from a horizontal face, which is formed by the upper edge section 92a of the handrail 92, and the hoisting device 30 does not protrude upward so as to be above the upper edge section 92a of the handrail 92 when viewed from a side. It should be noted that, as shown in FIG. 1, the upper operating device 20 also does not protrude upward so as to be above the upper edge section 92a of the handrail 92 when viewed from the side. Therefore, a height H3 of the vehicle for high lift work 10 is, when the hoisting device 30 is in the stored position, expressed by the distance between a ground G and the upper edge section 92a of the handrail 92, as with the work vehicle configured without providing the work platform in the hoisting device.

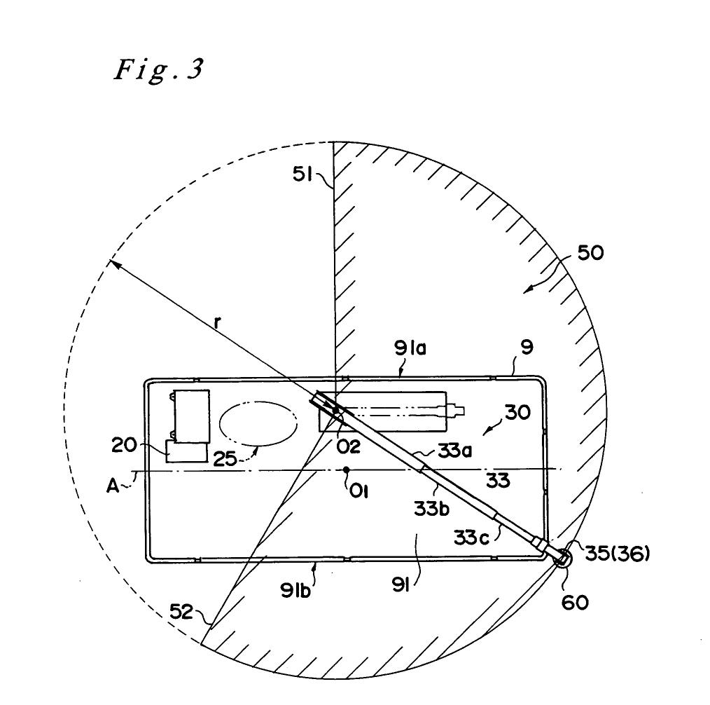

Moreover, in the sub-boom 33 of the hoisting device 30, a turning motion thereof is tolerated only in an angular range θ which is formed between border lines 51 and 52 shown in FIG. 2 and FIG. 3. In the present embodiment, the turning motion of the sub-boom 33 is tolerated from the storage location thereof to a position obtained after rotating approximately 120 degrees in the clockwise direction and to a position obtained after rotating approximately 90 degree in the counterclockwise direction.

On the other hand, when the hoisting device 30 is in the storage position thereof, the upper operating device 20 and the operating space 25, which are located in the direction opposite to the direction in which the sub-boom 33 extends, are positioned outside the angular range θ. Therefore, even when the hoisting device 30 is actuated, the sub-boom 33 and the hook 36 do not move in an upper part of the upper operating device 20 and of the operating space 25.

It should be noted that the turning post 32 is driven using a pinion mechanism (not shown). This mechanism is configured by: a rack, which is provided on the base 31, connected to a hydraulic cylinder, and can directly and reciprocally drive a predetermined stroke freely; a pinion which is geared with this rack and freely rotated; and a low-speed mechanism which reduces the speed of rotation of the pinion and turns the turning post 32 at a predetermined speed, wherein the pinion is rotated by the reciprocal direct movement of the rack and thereby the turning post 32 is turned. Further, a limit switch, which is attached so as to output a signal when the rack is directly driven by a predetermined amount, is provided in two locations. A control device, which stops the actuation of the hydraulic cylinder when a signal is outputted from each limit switch, is provided.

Accordingly, when the turning post 32 is turned in the clockwise direction when the hoisting device 30 is in the stored position, a signal is outputted from one of the limit switch to stop the hydraulic cylinder, and the turning motion of the turning post 32 is regulated when turned to approximately 120 degrees (when a border line 52 is reached). Similarly when the turning post 32 is turned in the counterclockwise direction, a signal is outputted from the other limit switch to stop the hydraulic cylinder, and the turning motion of the turning post 32 is regulated when turned to approximately 90 degrees (when a border line 51 is reached). It should be noted that such limit switches may be provided on the hydraulic cylinder side or on the rack side.

Further, in the sub-boom 33 of the hoisting device 30, a center of turning 02 is positioned in the right region A1. However, when the amount of outward protrusion of the sub-boom 33 viewed horizontally is made largest by raising the sub-boom 33 to a predetermined derricking angle so that it can pass the upper edge section 92a of the handrail 92 and extending the sub-boom 33 to the maximum stretched amount, the leading end of the sub-boom 33, the pulley 35, and the hook 36 are always positioned outside the work platform 9. Specifically, as shown in FIG. 3, the hoisting device 30 has, in plan view, has a fan-shaped work range 50 in which the amount of outward protrusion of the sub-boom 33 is the maximum working radius r and the angular range θ for allowing the turning motion is the central angle. Therefore, if the turning radius of the sub-boom 33 is the maximum working radius r, the hook 36 can always be positioned outside the work platform 9.

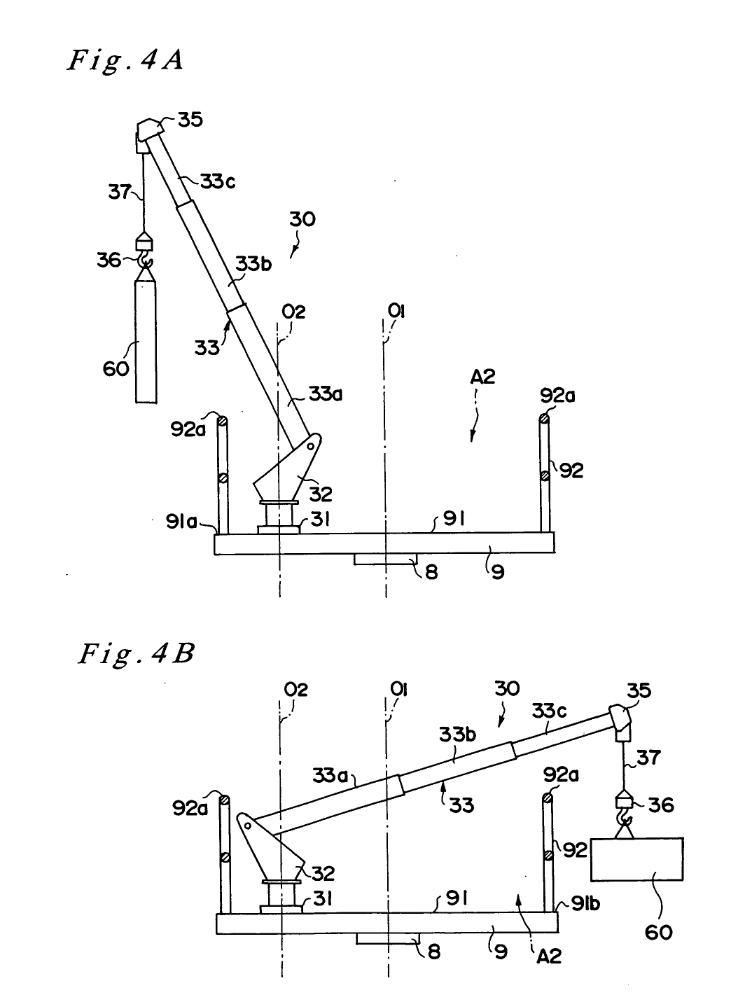

FIG. 4 shows a work of lifting the heavy load 60 by using the hoisting device 30 configured as described above. FIG. 4A shows a state in which the heavy load 60 is lifted up from the outside the margin which is in the vicinity of the hoisting device 30 (right margin 91a), and FIG. 4B shows a state in which the heavy load 60 is lifted up from the outside the margin which is far from the hoisting device 30 (left margin 91b).

In FIG. 4A, since the hoisting device 30 and the right margin 91a of the work floor 91 are close to each other, the leading end of the sub-boom 33 can be positioned outside the work platform 9 even when the sub-boom 33 is raised significantly. Therefore, even when the heavy load 60 is lifted up and hung in a vertical direction as shown in the figure, the sub-boom 33 can be raised so that a lower end of the heavy load 60 is positioned upper than the upper edge section 92a of the handrail 92, and thereby the heavy load 60 can be brought onto the work platform 9.

When the heavy load 60 is large in a lateral direction, the heavy load 60 may obstruct the sub-boom if the elevating angle is increased. In this case, as shown in FIG. 4B, the lifting work is performed from the outside of the left margin 91b. Since the left margin 91b is far from the hoisting device 30, the lower end of the heavy load 60 can be positioned higher than the upper edge section 92a of the handrail 92 even when the derricking angle is not increased, whereby the heavy load 60 can be easily brought onto the work platform 9.

Moreover, as shown in FIG. 4B, in order to bring the lifted heavy load 60 onto the work platform 9, suppose that the sub-boom 33 is turned 180 degrees so that it is brought into the state shown in FIG. 4A. At this moment, by setting the stretched amount and the derricking angle of the sub-boom 33 so that the turning radius of the sub-boom 33 becomes the maximum working radius r, the hook 36 is always caused to pas the outside of the work platform 9 and turned, thus the heavy load 60 can be moved without causing the heavy load 60 to hit the work platform 9 or pass an upper part of the work platform 9.

According to the configuration of the vehicle for high lift work 10 of the present embodiment described above, both the upper operating device 20 and the hoisting device 30 are disposed in the vicinity of the right margin 91a of the work floor 91, and are disposed in the right region A1, which is one of the right region A1 and left region A2 formed by dividing the rectangular work floor 92a into two vertically by the longitudinal direction axis A. Therefore, in the vicinity of the left margin 91b facing the right margin 91a, i.e. in the left region A2, there is formed a free space in which any particular device is disposed. Therefore, a wider space can be secured so that the worker can perform a movement and other work on the work platform 9, whereby working efficiency can be improved. It should be noted in the present embodiment that the hoisting device can be operated while moving it, thus a work can be performed efficiently using the hoisting device 30 in the left region A2.

Furthermore, even when the sub-boom 33 is raised significantly, the leading end of the sub-boom 33 and the hook 36 can be positioned outside the work platform 9 from the right margin 91a to which the operating device and the hoisting device are brought close, thus heavy load 60 can be easily brought to onto the work platform 9 even if the heavy load 60 is hung in a vertical direction. If the heavy load 60 might obstruct the sub-boom 33 because the heavy load 60 is large in a lateral direction and the raising angle is large, by lifting up the heavy load 60 from the left margin 91b in which the derricking angle can be reduced compared to a conventional embodiment where the hoisting device is disposed at the center O1, the heavy load 60 can be prevented from obstruct the sub-boom 33 and the heavy load can be easily brought onto the work platform 9 without causing the lower end of the heavy load to pass an upper part of the upper edge section 92a of the handrail. It should be noted that when carrying the heavy load 60 from the left margin 91b, the left region A2, which is the free space, can be used effectively, thus a vehicle for high lift work with good workability can be provided. In this manner, by selecting a margin for lifting up a heavy load in accordance with circumstances, a work can be performed efficiently.

The turning motion of the turning post 32 of the hoisting device 30, which exceeds the angular range θ shown in FIG. 2 and FIG. 3, is regulated, and the upper operating device 20 and the operating space 25 are positioned outside the angular range θ, thus the sub-boom 33 or hook 36 do not move the upper section of the upper operating device 20 and of the operating space 25. Therefore, the worker moving the work platform 9 and the worker operating the hoisting device 30 are different, and other worker is positioned in the operating space 25. Therefore, even if the worker operating the hoisting device 30 while moving in the left region A2 performs an erroneous operation, the worker moving the work platform 9 can be prevented from being caught between the work platform 9 and the hoisting device 30, thus a safe vehicle for high lift work can be provided. It should be noted that the three margins of the right margin 91a, the left margin 91b, and the rear margin 91c are provided with the work rang 50 in which the angular range θ for tolerating a turning motion of the sub-boom 33 exceeds 180 degrees, and the work platform 9 can be freely turned 360 degrees in a horizontal direction by the oscillating device 8, thus even if the angular range in which the turning motion is tolerated is limited, the workability is not deteriorated.

Even when performing a lifting work in any location, the hoisting device 30 is configured such that the sub-boom 33 can be turned to a position to which the heavy load can be easily carried without the work platform 9 being obstructed, thus a vehicle for high lift work, which is safe and can improve the working efficiency, can be provided.

Furthermore, in the vehicle for high lift work 10 of the present embodiment, the height H2 of the hoisting device 30 is set lower than the height H1 of the handrail 92 when the hoisting device 30 is in the storage position, thus the height H3 of the entire vehicle is as high as the upper edge section 92a of the handrail 92, as with a work vehicle of an embodiment which is not provided with the hoisting device 30. Therefore, a vehicle can travel in the same manner as the work vehicle of the embodiment which is not provided with the hoisting device 30. When the work platform 9 is moved when the hoisting device 30 is in the stored position, the work platform 9 can be moved in the same manner as the work vehicle of the embodiment which is not provided with the hoisting device, and the hoisting device 30 can be prevented from being obstructed by the surrounding structural objects.

Furthermore, compared to the conventional embodiment in which the height H2 of the hoisting device 30 is set higher than the height H1 of the handrail 92, the height of the center of gravity of the vehicle is low when the hoisting device 30 is in the stored position. Therefore, the maximum stable inclination angle can be prevented from being reduced and the running stability can also be prevented from being deteriorated. Moreover, it is not necessary to prepare a large number of mechanisms for improving the roll rigidity. Since the hoisting device 30 is provided with a stretchable sub-boom 33 and is disposed so that the heavy load 60 can easily be brought onto the work platform 9, even when the height H2 of the hoisting device 30 in the stored position is set low, the lifting workability is not affected.

The above has described the embodiments according to the present invention, but the vehicle for high lift work according to the present invention is not limited to the above embodiments and thus can be changed accordingly. For example, both the upper operating device 20 and hoisting device 30 may be provided in one of a rear region B1 or a front region B2 which are provided by dividing a width direction axis B. It should be noted that these two regions are merely examples to explain the embodiments. Therefore, as long as the upper operating device 20 or hoisting device 30 is disposed in the vicinity of one of the margins on the work floor 91, even if the upper operating device 20 or hoisting device 30 is disposed so as to stride over the longitudinal direction axis A or the width direction axis B, such a configuration does not deviate the scope of the present invention.

Moreover, the angular range for regulating the turning motion of the sub-boom 33 may be set so that the upper operating device 20 and the operating space 25 are positioned outside thereof, thus the angular range of the above embodiments may be changed accordingly.

In addition, the have has described the vehicle for high lift work 10 which is attached with the relatively large work platform 9 so that a large working space is secured at a leading end of the boom 5, but the form of the vehicle for high lift work is not limited to this form, thus various forms can be applied.

1. A vehicle for high lift work, comprising:
a vehicle capable of traveling;
a lifting and lowering device disposed on the vehicle;
a work platform which is attached to the lifting and lowering device and raised and lowered by the lifting and lowering device;
an operating device, provided on the work platform, for operating the lifting and lowering device; and
a hoisting device, provided on the work platform, for lifting a heavy load up and down,
wherein the operating device and the hoisting device are disposed in the vicinity of one of margins forming a floor face of the work platform.

2. The vehicle for high lift work according to claim 1, wherein the work platform is in the form of a rectangle in plan view, and, when an upper face region of the work platform is divided into a right region A1 and a left region A2 by a longitudinal direction axis A which passes through a center O1 of the upper face region and which is parallel with a long side of the work platform, the upper operating device and the hoisting device are provided so as to be adjacent to each other in the front-and-back direction in either the right or left region and are provided with an operating space therebetween.

3. The vehicle for high lift work according to claim 2, wherein the hoisting device is configured so that a turning motion thereof is allowed only within an angular range excluding the operating device and the operating space.

4. The vehicle for high lift work according to claim 1, wherein a turning motion of the hoisting device is allowed only within a predetermined angular range, and the operating device and the operating space for operating the operating device are positioned outside the angular range.

5. The vehicle for high lift work according to any of claims 1 through 4, wherein
the hoisting device comprises: a boom which is freely turned, derricked, and stretched; and a hook which is attached to a wire hanging downward from a leading end of the boom,
and the hoisting device is configured so that the hook can be always positioned outside the work platform and turned when the boom is turned at a predetermined derricking angle and by a predetermined stretched amount.

6. The vehicle for high lift work according to any of claims 1 through 4, wherein a handrail is arranged in a standing position so as to surround the floor face of the work platform, and an upper end of the hoisting device in a housing state is positioned below an upper edge of the handrail.

7. The vehicle for high lift work according to claim 6, wherein an upper end of the operating device is positioned below the upper edge of the handrail.
